(19) United States
(12) Patent Application Publication
(10) Pub. No.: US 2004/0063467 A1
(43) Pub. Date: Apr. 1, 2004

(54) Antenna arangements for flexible coverage of a sector in a cellular network

(76) Inventors: Joseph Shapira, Haifa (IL); Shmuel Miller, Oshrat (IL); Gideon Argaman, Kiryat Tivon (IL)

Correspondence Address: Anthony Castorina, G E Ehrlich Ltd, Suite 207, 2001 Jefferson Davis Highway, Arlington, VA, 22202, US

(21) Appl. No.: 10/470,467

(22) PCT Filed: Jan. 29, 2002
(86) PCT No.: PCT/IB02/01525

(51) Int. Cl. H04Q 7/20; H04M 1/00; H04B 1/38

(52) U.S. Cl. 455/561; 455/446; 455/424; 455/562.1

(57) ABSTRACT

A cell-shaping apparatus shapes coverage provided by individual sectors of a cellular communications network. A given antenna arrangement is provided which comprises at least two independently directable antenna arrays, and an electronic directing mechanism. The electronic directing mechanism independently directs at least one of plural beams formed by respective ones of the independently steerable antenna arrays.

### RELATED APPLICATION DATA

This application claims priority to U.S. Provisional Application No. 60/264,325, filed on Jan. 29, 2001 in the names of Miller et al., the content of which is hereby incorporated by reference herein in its entirety.

### FIELD OF THE INVENTION

The present invention, in certain respects, relates to cellular communications, and in other respects relates to approaches for shaping the coverage of a cell in a cellular communications system.

### DESCRIPTION OF BACKGROUND INFORMATION

In existing cellular networks some antennas form two diversity antenna beams aligned so that both beams point in the same direction, thus nominally covering the same area.

### SUMMARY

In accordance with one aspect of the invention, an antenna arrangement is provided for a given sector of a cell. The arrangement generates plural antenna beams that can be independently directed horizontally (by steering) and/or vertically (by squinting), to achieve rich coverage shaping possibilities. Such an antenna arrangement may comprise two arrays, each forming an independently directable beam. The arrays can be controlled to optimize communications per user (thus, at base band). Both the sector beamwidth and its direction can be modified.

### BRIEF DESCRIPTION OF THE DRAWINGS

FIG. 1A is an overview schematic of a three-sector embodiment of a base station antenna arrangement;

FIG. 1B is a schematic diagram of an embodiment of a given antenna arrangement for a given sector;

FIG. 2 is an illustration of example beam patterns that may be generated by the antenna arrays of the arrangement shown in FIG. 1;

FIG. 3 is an illustration of the power-sum coverage of a base station arrangement;

FIG. 4 is a top view of an exemplary embodiment of one two-column array;

FIG. 5 is a partial front view of the two-column array of FIG. 4;

FIGS. 6A-6D are simulations of beam formation with the illustrated two-array arrangement;

FIG. 7 is a side view schematic of an operational receive sub-system capable of squinting (vertical adjustment) of two respective beams produced by a pair of two-column arrays;

FIG. 8 is a side view schematic of a “load measurement” receive sub-system capable of squinting (vertical adjustment) of two respective beams produced by a pair of two-column arrays;

FIG. 9 is a functional diagram that illustrates a method of producing two independent beams with the embodiments of FIGS. 7-8;

FIG. 10 is a more detailed block diagram of a receive sub-system; and

FIG. 11 is a more detailed block diagram of another receive sub-system.

### DETAILED DESCRIPTION

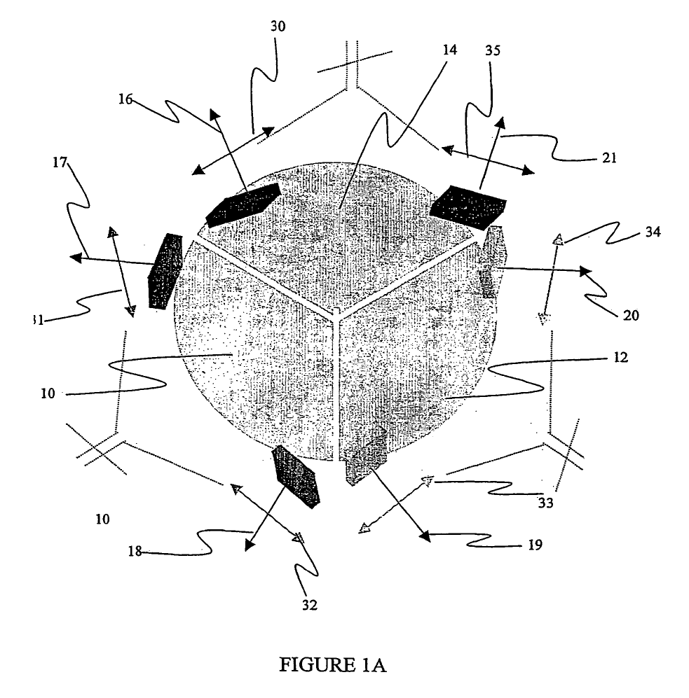

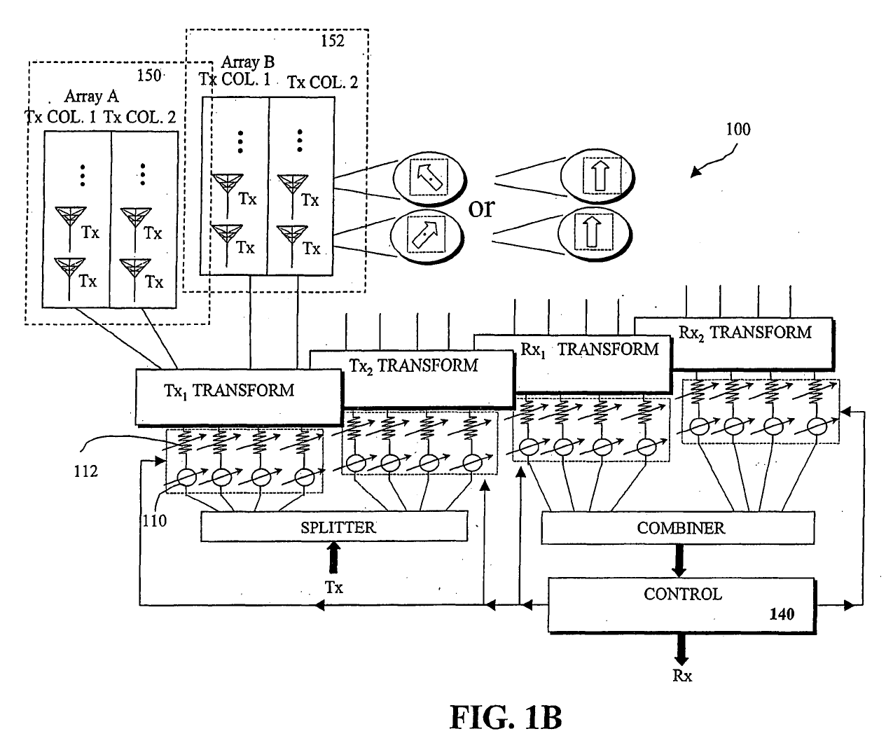

FIG. 1 shows one illustrated embodiment of an transmit and receive antenna arrangement 100 for a base station at a given cell. The figure shows parts of such antenna arrangement, including a given transmit antenna arrangement 150, 152 corresponding to a transmit portion of a given sector. Specifically, in the illustrated embodiment, a given antenna arrangement for a given sector has two arrays, each comprising a 2-column array (Tx col. 1 and Tx col. 2). A 2-column array may be similar in appearance to a single column array, and may have antenna elements that are vertically or cross-polarized, in Tx and/or Rx.

Each array (Tx or Rx) incorporates phase-shifters 110 that facilitate beam tilting (in elevation) as well as beam steering (in azimuth). Controllable attenuators 112 may be provided in the Tx and Rx paths, in cascade to the phase shifters—to provide further degrees of freedom to shape the Tx and Rx beams.

In accordance with a more specific embodiment, each pair of 2-column arrays is placed from each other at a distance between 10λ and 20λ

FIG. 1A demonstrates a 3-sector cell with flexible directable antenna arrays. The angular coverage of the sectors 10, 12, and 14 although shown as uniform does not necessarily have to be uniform. The choice of angle between the bore sights of the pair of arrays in each sector (as shown by arrows 16-21) offers an initial degree of freedom in changing the width of the sector coverage. Each array is then allowed to steer its beam electronically in a phased array mode, as shown by arrows 30-35. Synchronized beam steering provides coverage shifting to that sector, while unsynchronized steering changes the sector coverage width.

While the embodiments herein provide a pair of arrays for each sector, each such array having two columns of antenna elements, other types of arrays may be employed. For example, an array arrangement may be provided that can direct at least one beam of a given sector in relation to the position of at least one other beam for the same given sector.

The beam directing of each array may be combined with the coverage smoothing offered by the diversity reception and transmission that combine the coverage of the individual arrays into a smooth and continuous coverage within and between the sectors. This is further explained in the following.

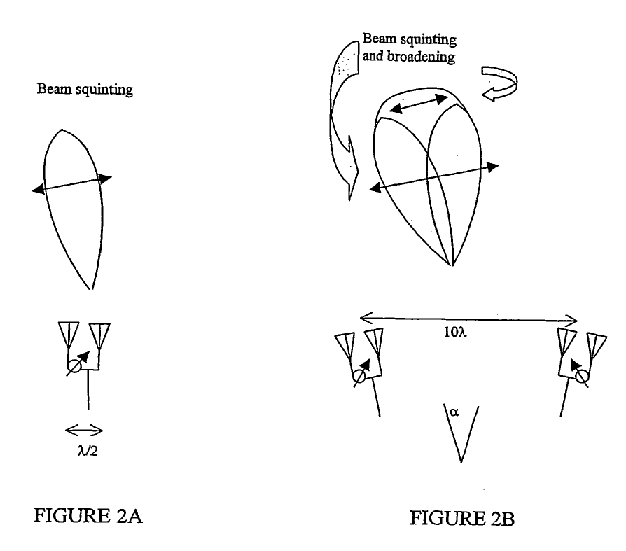

Each 2-column array forms a beam by coherently combining (in Rx) the received signals from each column, or coherently dividing (in Tx) the transmitted signal into the two columns through a phase shift network Upon changing the phase-shift between the 2 columns, the resulting beam pattern shifts in azimuth as depicted in FIG. 2A.

To get a variable sector coverage beamwidth, each 2-column array is steered independently, and the sum (diversity-combining) of the power coverage in azimuth determines the sector coverage, as seen in FIG. 2B.

Note that a maximal-ratio-combining receiver (either at the base station or at the mobile station) results in an output signal-to-noise power ratio (SNR) that is equal to the sum of its branches input SNR's. In a fading environment, the diversity gain achieved is approximately given by the following empirical expression (See A. M. D. Turkmani, A. A. Arowojolu, P. A. Jefford, and C. J. Kellett: “An Experimental-Evaluation of the Performance of Two-Branch Space and Polarization Diversity Schemes at 1800 MHz,” IEEE Transactions on Vehicular Technology, Vol.VT-44, No. 2, pp. 318-326, May 1995, incorporated herein by reference.) (for MRRC diversity gain at 90% signal reliability):

G[dB]7.14·exp(−0.5ρ−0.11Δ[dB]) (1)

[ρthe correlation coefficient between the two branch signals, Δ the dB difference between the mean power of the 2 branch signals.]

Thus, In general, the diversity gain is the highest for equal power inputs (Δ=0 dB), which are uncorrelated (ρ=0). Unequal power at the diversity branches, and/or correlation between the inputs reduces the diversity gain with respect to the highest power branch.

Thus, the areas where the two sector beams (‘right’ and ‘left’) overlap will result in higher diversity gain, thus in better coverage. When the beams are steered away from each other, the overlap shrinks, thus the radial coverage will be reduced, but this is usually expected of a broader beam (antenna gain is inversely proportional to its beamwidth).

An additional degree of freedom is the mechanical angular offset by which each of the 2-column arrays is placed during installation. FIG. 2b denotes a mechanical offset, which will usually be symmetric with respect to the nominal sector's bisector.

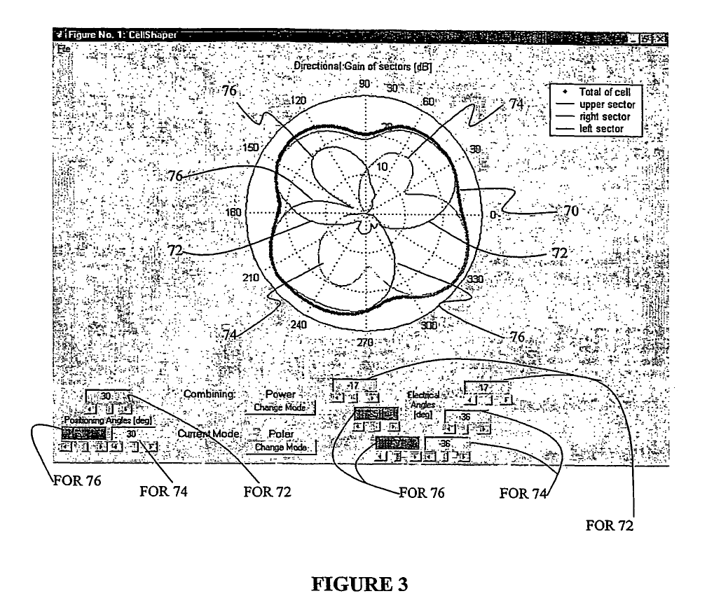

This arrangement allows the coverage of a sector to extend much beyond 120°. An example of the power-sum coverage (70) of the illustrated embodiments for 3 sectors (72, 74, and 76) is presented in FIG. 3.

When transmitting the same radio frequency signal through two distant antennas (as is done in these embodiments) the array pattern will have many nulls and grating lobes, all changing in an unpredictable manner (in a practical installation). Therefore, in a system with one composite Tx signal from the sector, one of the two 2-column arrays transmits the original composite signal while the other 2-column array transmits a diversity signal. In one embodiment the diversity signal is a delayed version of the original signal. This method is called time-delay transmit-diversity (TDTD). A delay is chosen to minimize the correlation between the two simultaneous transmissions, thus to minimize the in-cell interference caused by the TDTD system. Other diversity transmission methods, such as Phase Swept Transmit Diversity (PSTD), Space-Time Transmit Diversity (STTD), Orthogonal Coding, etc. may be used in the embodiments.

The coverage shaping of the cell may be controlled by several factors, including:

(A) The gain of each array. The beamwidth of the two-column array is determined by the array configuration. However, the gain in the direction of the horizon may also be determined in addition by the vertical beam pointing/tilting.

(B) The effective isotropic radiated power (EIRP) of each array, determined by the transmit power to that array and its gain.

(C) The angle setting between the mechanical boresights of each array pair.

(D) The angle between the (electrically controlled) boresights of the paired arrays.

(E) The synchronized steering of the beams for each paired arrays.

(F) The vertical beam control (beam tilt) for each array.

(G) The transmission power control for each array.

(H) Separate controls over all these parameters in receive (reverse link) and in transmit (forward link) modes.

It should be noted that any applicable transmit-diversity method may be utilized, instead of or in addition to the one illustrated above (namely TDTD). For example, phase-swept transmit diversity (PSTD) and space-time block-codes (STBC) transmit diversity apply as well. With TDTD or PSTD it is enough to have a single transmit output from the sector, whereas in the other methods the sector may require two transmit outputs, each will feed one of the two 2-column arrays of the sector.

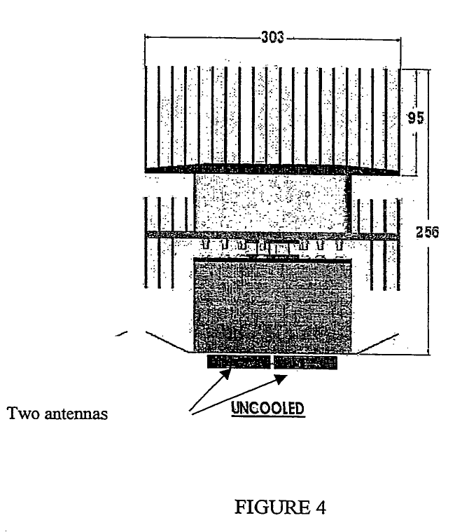

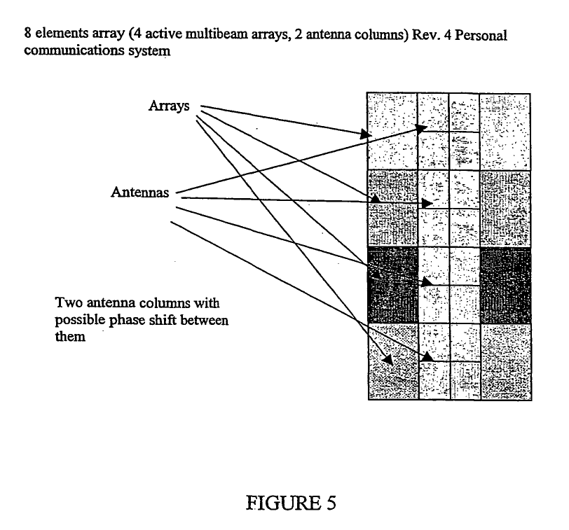

Another possible embodiment comprises active multibeam arrays. FIGS. 4 and 5 demonstrate a 2-column active array based on active multibeam arrays.

The embodiment of the illustrated embodiments in-the Rev. 4 personal communications system shown in the above Fig. emphasizes its simplicity; the interfacing with the BS sector is simple as for current systems. The provisions for TDTD are all at the out door equipment and no modifications are required at the BS or the MS.

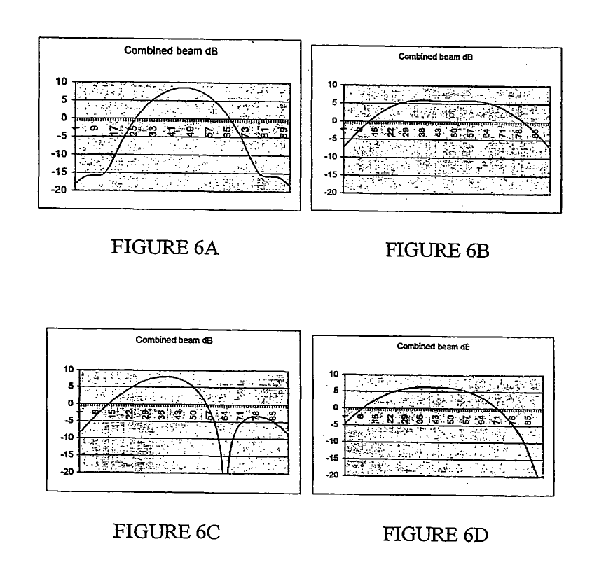

The sector coverage scheme is shown is FIG. 6. The antennas in a fairly balanced cell are oriented around the 120° sectorization scheme. A beam squint of up to ±30° is possible with the 60° beam, formed by the antenna column pair (FIG. 2A). The beams of two diversity arrays can be split by an offset angle α mechanically, as a pre-set (during installation), and further split electronically, to form a ‘coverage’ beamwidth of up to 120°. The Tx diversity keeps the beams' signals uncorrelated and thus allows for their summation at the MS Rake receiver (FIG. 2B).

A simple simulation of the beam forming is shown in FIGS. 6A-6D (in addition to that presented in FIG. 3). The parameters for the simulations of FIGS. 6A-6D are listed in the table below:

| | | | | FIG. 6D |
|---|---|---|---|---|
| α° | 30 | 30 | 30 | 30 |
| Beamwidth° | 52 | 100 | 54 | 94 |
| Boresight° | 0 | 0 | 14 | 8 |

Full Angular Agility of Cell Shapers

In an embodiment the six 2-column arrays that comprise the cell shaper antenna sub-system (FIG. 1) are connected to the base-station via an RF switch assembly that are enabled to cyclically shift the assignments of arrays to sectors (α, β, γ) as follows:

In one setting state of the switch assembly arrays A1 and A2 feed sector a, arrays B1 and B2 feed sector β, and arrays C1 and C2 feed sector γ. In the second setting state of the switch assembly array C1 and A1 feed sector α, arrays A2 and B1 feed sector β, and arrays B2 and C1 feed sector γ. This further enables the direction of the variable beamwidth beams of the three sectors to any direction over the full 360 degrees, with no limitations incurred by the electronic steering which is limited to ±30 degrees. The realization of the switch assembly is possible in several ways, basically forming a system of several SPDT switches. One such embodiment includes three SPDT switches for the Tx paths, and another set of three SPDT switches for the Rx paths.

Measurement of the Angular Distribution of the Load, and Annular Location of MS

A few objectives of the optimization of cellular radio coverage are to maximize the capacity in the network with the given resources, and to maximize the quality of service. A rough but simple estimate of the required link resources is given by measuring the total power transmitted and received. The objective is then to measure the received power as a function of the angle of arrival at the BTS antenna The angular resolution for this measurement is the subject of the following section. This reverse-link noise rise gives some information on the site traffic load. Additional important information is the forward-link total transmitted power. The measurements of both forward and reverse links' power enable the optimum cell shaping control for load and link balancing.

The measurement of cell load via power rise (over thermal) in the reverse link (see, for example, TIA/EIA Bulletin TSB84-A, August 1999, pp. 94-96) and the measurement of load utilizing perturbation techniques also exists.

Information on the location of the active MS is required for global optimization of the CDMA coverage, as discussed in at least one of the commonly assigned patents incorporated by reference below. The angular measurement of the MS location is the subject of the following part of the illustrated embodiments. The underlying method for the measurement of sector load distribution relies on the reverse-link power over thermal noise, measured in narrow beams that cover an angular part of the sector and scan the sector angular span.

Angular Location Measurement

The angular location may be measured via each of the two methods outlined above, while scanning the sector with narrow Rx beams.

Embodiment of the Receive Sub-System

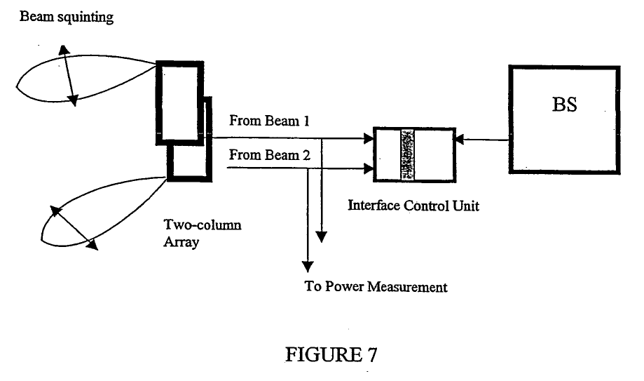

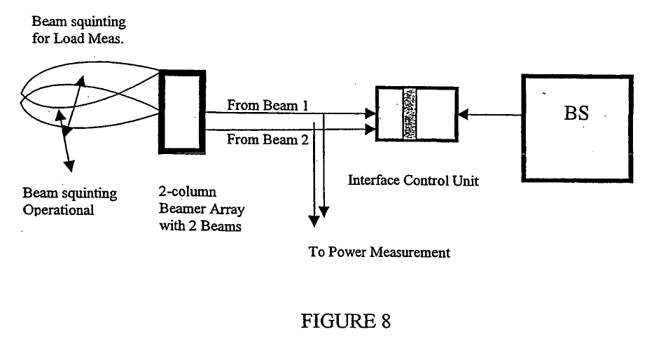

There are several alternatives for the implementation of the receiver chain. The first embodiment (i.e., the embodiment in FIG. 7) is presented here for exemplary purposes. The second embodiment (i.e., the embodiment in FIG. 8), and two variations for its implementation (a parallel and a cascade one), will be considered in the discussion below.

In the discussions that follow, an operational beam is a beam that serves for the cellular sector communications. A measurement beam is an auxiliary beam that serves only for power measurements in the reverse link.

The embodiment illustrated in FIG. 7 uses the operational receive link per scanning beam (provided out of a 2-column active multibeam array). Since there is a tower-top low noise amplifier (LNA) at the antenna port, there is no problem in splitting (or coupling off a secondary receive channel) just for the reverse link power measurement. Each sector is equipped with two such squinted beams, and the power measurements may be performed on both.

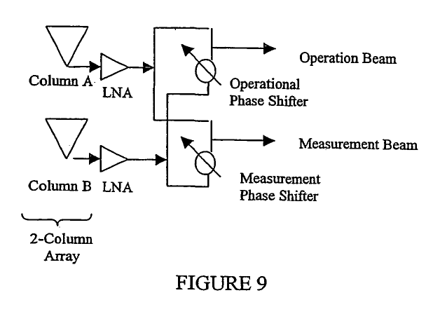

An alternative embodiment, illustrated in FIG. 8, allows the formation of another set of squinted beams, independently of the operational beams, from the same 2-column array. Such a pair of beams is formed out of each of the two arrays per sector. The two-column array produces the two independent beams as indicated in more detail in the scheme of FIG. 9.

Note that due to the existence of LNA's at the antenna's ports it is possible to split the received signals per column, and recombine them using two different phase shifters to achieve two independently scanning beams, with no loss in sensitivity.

With the measurement beams in the embodiment of FIG. 9 it is possible to scan the sector independently of the positioning of the operational beams. Stepping the beams each over a range of ±25° enables the production of an angular load distribution over the sector, with a “window function” of 60° (which is roughly the beam-width of the beam produced from the 2-column array). Since the window pattern is known, we can perform an inverse operation (de-convolution) to obtain the sector angular user distribution. Method II, illustrated in FIG. 8, is a preferred embodiment and may be realized as depicted in FIG. 9.

Using only one beam, as in FIG. 7, with tapping-off for the measurement port, the measurements are restricted only to the angular sub-sector covered by the operational beam. It is possible to slightly offset the beam pointing direction around its nominal (operational) pointing angle (say, ±15° maximum) to measure the load gradient around the operational point This means that the test can determine whether the beam is pointed at the maximum load direction.

With measurement beams, it is possible to measure only power in up-link. The use of delay switching, as used in the patents referenced below, is not applicable here since delay is acquired from the BS, and these measurement beams do not enter the BS. On the other hand, with option I both power and/or delay may be measured, but only on the two operational beams per sector.

Instead of implementing the embodiment of FIG. 8 with the operational two-column arrays, it is possible to include an additional (to the operational array) receive-only array that is mounted on the same tower and in parallel with the operational system, and serves for load measurements by power in up-link.

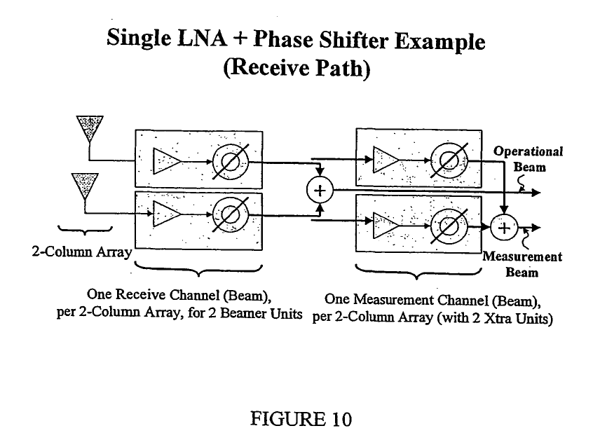

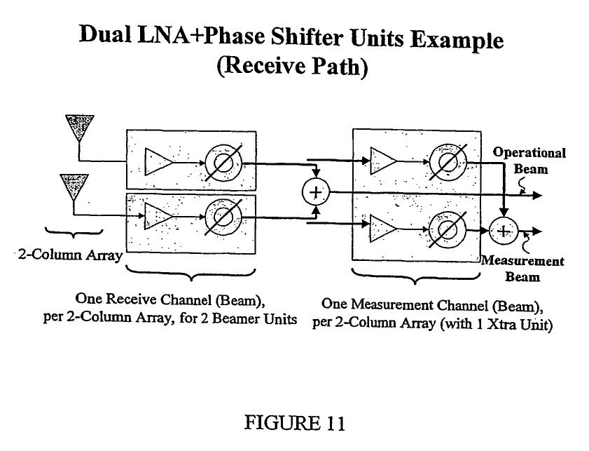

In FIGS. 10 and 11, an alternative implementation of the two-column array with a cascade arrangement of phase-shifters is shown. This arrangement allows the use of integral dynamically controlled coverage shaping units, which include LNAs and phase-shifters. The difference between the two embodiments in FIGS. 10 and 11 is in the structure of the coverage shaping units that are employed: a unit with a single LNA followed by a phase-shifter, or a unit with a pair of LNAs, each followed with an independent phase-shifter. Whereas with a single LNA-phase-shifter unit—two units are required for the formation of the auxiliary measurement beam per two-column array, with the dual LNA-Phase shifter unit—just one unit suffices for this purpose. In FIGS. 10 and 11, the circular element 100 is a controlled phase shifter.

Another implementation may be provided of an antenna that uses two arrays, each forming an independent steerable beam, and that can optimize communications per user (thus, at base band). One possible application of such a system is to adaptively form a beam per-user, which is capable of nulling interference (one interferer can be nulled with a pair of columns), and with two such independent arrays, perform maximal ratio combining in the up-link (to enjoy the space diversity gain), and beam steer the two beams (possibly while using S-T [Space-Time (S-T) coding is part of the existing 3G Cellular Standards.] coding) in the same direction in down-link.

Optimizing the coverage of a base station (BS) in a cellular telephone system requires control of two main parameters: the effective isotropic radiated power (EIRP) of the base station and gain/transmit (G/T) shaping within the sector (to cope with variations in load and in environment within and between the sectors). Diversity enhancements contribute additional link margin and thus help reduce the transmit power at both the base-station (BS) and mobile-station (MS) (thus increasing efficiency and reducing the self-interference), extend coverage, and cover radio holes. Beam tilting is a powerful tool in balancing links and interference between cells. The remote control of all the above offers a huge savings in installation and in network tuning, and further enables dynamic adjustments/optimization in response to load changes.

Commonly assigned U.S. patent application Ser. No. 09/171,986, for Method and System for Improving Communications, filed Dec. 30, 1998; Ser. No. 09/389,053, for Scalable Cellular Communications System, filed Jul. 21, 1999; Ser. No. 09/357,845 for Scalable Cellular Communications System filed Jul. 21, 1999; and Ser. No. 09/357,844 for Active Antenna Array Configuration and Control for Cellular Communication Systems, filed Jul. 21, 1999, each of which is incorporated herein by reference in its entirety, are related to this application. The illustrated embodiments may also include multiple diversities, polarity matching; and beam tilting.

To facilitate the automatic control and optimization of an illustrated embodiment of the illustrated embodiments, load measurement schemes in reverse and forward links are presented that may serve as inputs to the control algorithms.

As part of an illustrated embodiment, a controlled coverage mechanism is set forth formed by steering beams and by applying the transmit diversity. The load is measured to provide information as to how to optimize the coverage with the control we provided.

It will thus be seen that the objects of these illustrated embodiments have been fully and effectively accomplished. It will be realized, however, that the foregoing preferred specific embodiments have been shown and described for the purpose of illustrating the functional and structural principles of these illustrated embodiments and are subject to change without departure from such principles.

What is claimed is:

1. A cell-shaping apparatus for shaping coverage provided by individual sectors of a cellular communications network, said apparatus comprising a given antenna arrangement for a given sector, said given antenna arrangement comprising:
at least two independently directable antenna arrays, and
an electronic directing mechanism to independently direct at least one of plural beams formed by respective ones of said independently steerable antenna arrays.

2. The cell-shaping apparatus of claim 1, wherein said directing mechanism comprising an azimuthal direction control to control the beam directions to alter the azimuthal direction of coverage for the given sector.

3. The cell-shaping apparatus of claim 1, wherein said directing mechanism comprises an azimuthal width control to control the beam directions to alter the azimuthal width of coverage for the given sector.

4. The cell-shaping apparatus of claim 1, wherein said directing mechanism comprises an elevation control to control the beam directions to alter the elevation direction of coverage for the given sector.

5. The cell-shaping apparatus of claim 1, wherein each said antenna array comprises at least two columns of antenna elements.

6. The cell-shaping apparatus of claim 2, wherein each said antenna array comprises two columns of antenna elements.

7. The cell-shaping apparatus of claim 1, wherein said directing mechanism comprises a phase-shifter to direct a given beam.

8. The cell-shaping apparatus of claim 7, wherein said directing mechanism further comprises a controllable attenuator, in cascade with said phase-shifter.

9. The cell-shaping apparatus of claim 1, wherein said directing mechanism comprises an azimuthal control to independently direct at least a pair of the beams synchronously to alter the azimuthal direction of the coverage of the sector and a sector composite beam width control to direct at least a pair of the beams unsynchronously to alter the width of the coverage of the sector.
